(19) United States
(12) Patent Application Publication
(10) Pub. No.: US 2010/0202166 A1
(43) Pub. Date: Aug. 12, 2010

(54) ENERGY SAVING LUMENS SETTABLE DEVICE FOR FLUORESCENT LAMPS

(75) Inventor: Mohamed Sirajjudin, Tamil Nadu (IN)

Correspondence Address: YOUNG & THOMPSON, 209 Madison Street, Suite 500, Alexandria, VA, 22314, US

(73) Assignee: ADVANCED ENVIRONMENTAL TECHNOLOGIES LIMITED, Auckland (NZ)

(21) Appl. No.: 12/599,604

(22) PCT Filed: Apr. 15, 2008
(86) PCT No.: PCT/NZ2008/000081

§ 371 Date: Nov. 10, 2009

(30) Foreign Application Priority Data
May 10, 2007 (NZ) 555103

(51) Int. Cl. H02M 3/335

(52) U.S. Cl. 363/21.17

(57) ABSTRACT

A circuit to supply an AC voltage to a fluorescent lamp load from an AC supply converts the supply to DC, boosts the voltage in a converter and then drives an inverter from the smoothed boosted voltage in such a manner that the inverter will not start if the load is too low and the inverter frequency is almost constant. The power factor of the circuit is maintaining very close to unity.

### TECHNICAL FIELD

The invention generally relates to a driver for fluorescent lamps.

More particularly the invention relates to a driver for fluorescent lamps which allows control of the lumen output of a fluorescent lamp and consumes power efficiently.

### BACKGROUND ART

Drivers for fluorescent lamps are known and it is also known to provide controls on these so that they produce a required light output despite varying input voltage. Such known driver circuits often provide other than a unity power factor and will still consume power even if a fluorescent lamp is not working.

Therefore a need exists for a solution to the problem of controlling the light output of a fluorescent lamp while providing a close to unity power factor and limiting current consumption where a lamp fails to strike.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in an apparatus for providing a supply voltage to an AC load, the apparatus being connected to an AC supply and providing the AC current to a bucking transformer under repetitively switched control, the bucking transformer output being rectified and supplying a half bridge inverter having at least two output transistors in half bridge arrangement, the inverter haying a current output including a transformer winding, the transformer winding being coupled to two other windings operable to drive the inverter, whereby if no output current can be provided because of output circuit conditions, the inverter will not operate characterised in that the other windings drive the bases of the half bridge transistors and are DC isolated, and the base/emitter voltage of the transistors in the turn off direction is limited by a unidirectional component network.

Preferably the unidirectional component network is the series combination of a diode and a resistor.

Preferably only one of the output sides of the half bridge has a transistor emitter resistor and only the other side of the bridge has a base pull up resistor.

Preferably there are two parallel transistors in each side of the half bridge arrangement.

A method of providing an AC output from an AC input comprising rectifying the AC input to power a bucking converter, the converter being of controllable power factor, the smoothed converter output supplying an inverter, the inverter output current passing through a transformer winding, other windings of the transformer being operable to drive inverter control switches such that if the output circuit conditions reduce the output current below a minimum, the inverter will not operate, characterised in that the transformer windings driving the inverter control switches are DC isolated and the switch control electrode is regulated to limit the applied control electrode voltage when the switch is cut off.

Preferably the switch control electrode limiting is provided by a series resistor and diode.

Preferably the smoothed converter output is regulatable for voltage.

Preferably the frequency of the inverter is substantially constant within the working voltage range.

Preferably the inverter is a half bridge inverter.

These and other features of as well as advantages which characterise the present invention will be apparent upon reading of the following detailed description and review of the associated drawings.

### BRIEF DESCRIPTION OF THE DRAWINGS

FIG. 1 is a circuit diagram of an embodiment of the invention.

FIG. 2 shows the layout of the majority of the circuit components on a printed circuit board.

FIG. 3 shows the layout of the circuit board track.

FIG. 4 shows the layout of most of the remaining circuit components on a daughter board.

FIG. 5 shows the layout of the track on the daughter board.

### DESCRIPTION OF THE INVENTION

Referring now to FIG. 1 AC mains of 50 Hz or 60 Hz at a voltage from 120 to 277 volts is applied to the circuit at 101, 102, and passes via a fuse 103, spike eliminating bifilar inductor 104 and suppression capacitors 105, 106 which assist in eliminating noise on the input AC line, to a bridge rectifier of diodes 107. The output is smoothed by capacitor 108 and applied via bucking transformer 109 to FET transistor 112 and thence via load sampling resistors 113, 114 returns.

The buck circuitry and phase angle of conduction at transistor 112 is controlled by integrated circuit 111, typically a Motorola MC3326P or L6563N, via resistor 110. The integrated circuit is supplied with power via resistor 115 and smoothing capacitor 118 at startup. A voltage sample input is provided from the voltage divider of resistors 122, 123 and integrating capacitor 124. Input via resistor 121 triggers the control of transistor 112 assisted by quickstart capacitor 124. A bootstrap supply of about 18 volts is provided via resistor 117, capacitor 119 and diode 116 provides power to the integrated circuit 111 once the bucking supply is running. Resistor chain 127, 128, 130 and 132 controls the output voltage via the integrated circuit 111 and the buck converter and resistors 128, 130 may be switched by switches 129, 131 to set a desired output voltage level controlling the lumen level emitted by the attached fluorescent lamps 163, 164. Rather than using switches and fixed resistors the output voltage may be varied continuously if a variable resistor is used as the adjustment element.

The fluorescent lamps are driven by a half bridge inverter circuit fed from the output of bucking transformer 109 via high frequency rectifier 126 and smoothing capacitors 137, 138 which have bleed resistors 135, 136.

The inverter has paralleled upper and lower transistors 146, 147 and 154, 155 forming a half-bridge arrangement. The lower of a pair of inverting transistors 154, 155 is triggered into conduction by resistor 159 and capacitor 160 at startup via pullup resistor 153. Trifilar windings 139, 140, 141, preferably on a ferrite core, act to bootstrap the inverter into oscillation, with the proviso that if no current flows in output winding 141 the oscillation will not be maintained. Hence no load produces no oscillation. Capacitors 142, 143 DC isolate the windings 139, 140 and with the aid of resistors 148, 156 and reverse conducting diodes 149, 157 act to regulate the turn-on voltage at the transistor bases. Inductors 145 and 152 act to set the frequency of operation of the inverter in conjunction with capacitors 142, 143. Resistors 148, 156 and diodes 149, 157 assist in waveshaping while snubbing diodes 151 and 158 act to protect the transistors from reverse voltages. This combination of components provides a stable frequency of operation despite changes in the input voltage to the inverter and allows control of the light output from the lamps by varying the applied voltage to the inverter, thus varying the output voltage to the fluorescent lamps and the light output from those lamps.

Inverter output via winding 141 and ballast chokes 161, 162 which define the operating frequency of the inverter is supplied to the lamp filaments via capacitors 165, 166 and acts to strike and maintain the lamps. Current return is via balanced capacitors 137, 138.

The inverter typically runs at between 30 KHz and 40 KHz. Because the inverter frequency is set by fixed components and the load is virtually constant both the frequency and voltage of the output are stably controlled despite changes in the AC input voltage over a 120 to 277 volt range.

Light output of the fluorescent lamps is controlled with switches 129, 131 which set the supply voltage for the inverter and maintain it sensibly constant despite variations in mains supply voltage without varying the frequency of operation of the inverter. This stability also allows use of fluorescent lamps of several differing types, for instance compact or linear styles.

Preferred component values are:

TABLE 1

| PART | Ref. | DESCRIPTION | VALUE |
|---|---|---|---|
| 103 | F1 FIG. 2 | Fuse | 4 A 300 V |
| 104 | T1 FIG. 2 | Bifilar line filter | 2 × 10 mH |
| 105 | CY FIG. 2 | Capacitor | 2n2F |
| 106 | CX FIG. 2 | Capacitor | 0.33 uF |
| 107 | D1, D2, D3, D4 | Diode | 1N4007 |
| | FIG. 2 | | |
| 108 | C1 | Capacitor | 33 nF |
| 109 | T2 FIG. 2 | Transformer | EE25/13/7 90 turn |
| | | | 1^{D} 7 turn 2^{D} |
| 110 | R5 FIG. 2 | Resistor | 10E |
| 111 | IC1 FIG. 2 | IC | L6562N |
| 112 | Q1 FIG. 2 | FET | IRFBC40 |
| 113, 114 | R5, R6 FIG. 2 | Resistor | 1E |
| 115 | R3 FIG. 2 | Resistor | 240K |
| 116 | D3 FIG. 2 | Diode | 1N4150 |
| 117 | R2 FIG. 2 | Resistor | 100E |
| 118 | C2 FIG. 2 | Capacitor | 22 uF |
| 119 | C6 FIG. 2 | Capacitor | 12 nF |
| 120 | D2 FIG. 2 | Diode | 1N5248B |
| 121 | R1 FIG. 2 | Resistor | 68K |
| 122 | R9 FIG. 2 | Resistor | 1.24M |
| 123 | R10 FIG. 2 | Resistor | 10K |
| 124 | C7 FIG. 2 | Capacitor | 10 nF |
| 125 | C3 FIG. 2 | Capacitor | 0.68 uF |
| 126 | D1 FIG. 2 | Diode | MUR160 |
| 127 | R7 FIG. 2 | Resistor | 1M |
| 128 | RA FIG. 2 | Resistor | 100K |
| 129, 131 | SW1 | DIP switch | Dual on/off |
| 130 | RB FIG. 2 | Resistor | 100K |
| 132 | R8 FIG. 2 | Resistor | 5.6K |
| 133 | C4 FIG. 2 | Capacitor | 47 uF |
| 134 | C5 FIG. 2 | Capacitor | 47 uF |
| 135, 136 | R11, R12 FIG. 2 | Resistor | 1.2M |
| 137, 138 | C8, C9 FIG. 3 | Capacitor | 0.22 uF |
| 139, 140, | TA, TC, TB | Trifilar inductor | resp. 5, 5, 7 |
| 141 | FIG. 3 | | turns on T10 core |
| 142, 143 | C1, C2 FIG. 3 | Capacitor | 0.33 uF |
| 145, 152 | L1, L2 FIG. 3 | Inductor | 56 uH |
| 146, 154 | Q1, Q2 FIG. 3 | Transistors | MJE13007A |
| 147, 155 | Q2, Q3 FIG. 2 | Transistors | MJE13007A |
| 148 | R1 FIG. 3 | Resistor | 100E |
| 149, 157 | D1, D2 FIG. 3 | Diode | 1N4148 |
| 150 | R4 FIG. 3 | Resistor | 0.62E |
| 151, 158 | D3, D4 FIG. 3 | Diode | 1N4007 |
| 153 | R2 FIG. 3 | Resistor | 470K |
| 156 | R3 FIG. 3 | Resistor | 100E |
| 159 | R5 FIG. 3 | Resistor | 470K |
| 160 | C3 FIG. 3 | Capacitor | 0.33 uF |
| 161, 162 | L1, L2 FIG. 2 | Inductor | 5.2 mH air gap |
| 163, 164 | not shown | Fluorescent lamp | |
| 165, 166 | C10, C11 FIG. 2 | Capacitor | 0.01 uF |

The L6562N controller may be set up in known manner to provide a power factor on the supply of better than 0.99. Other controllers may be used to provide a stable inverter supply voltage while maintaining a high power factor.

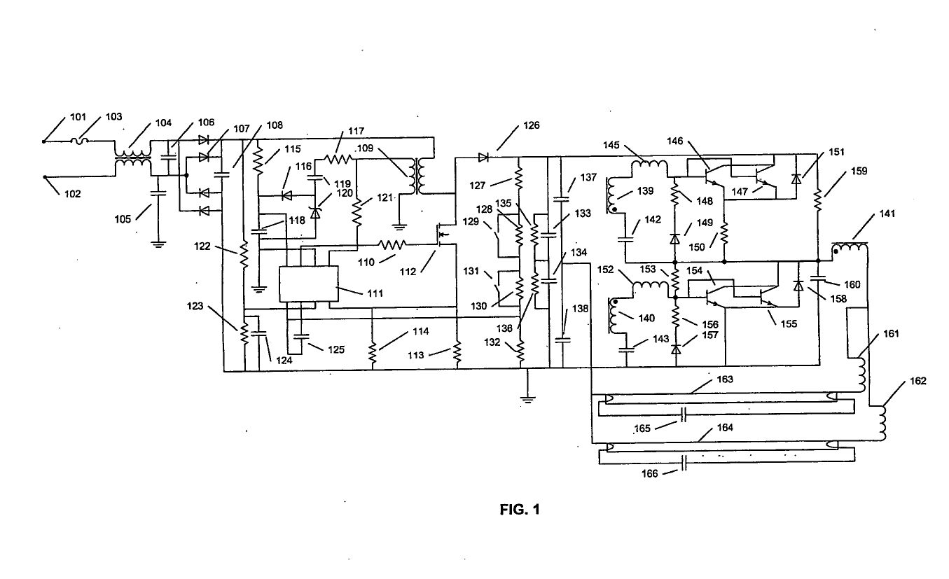

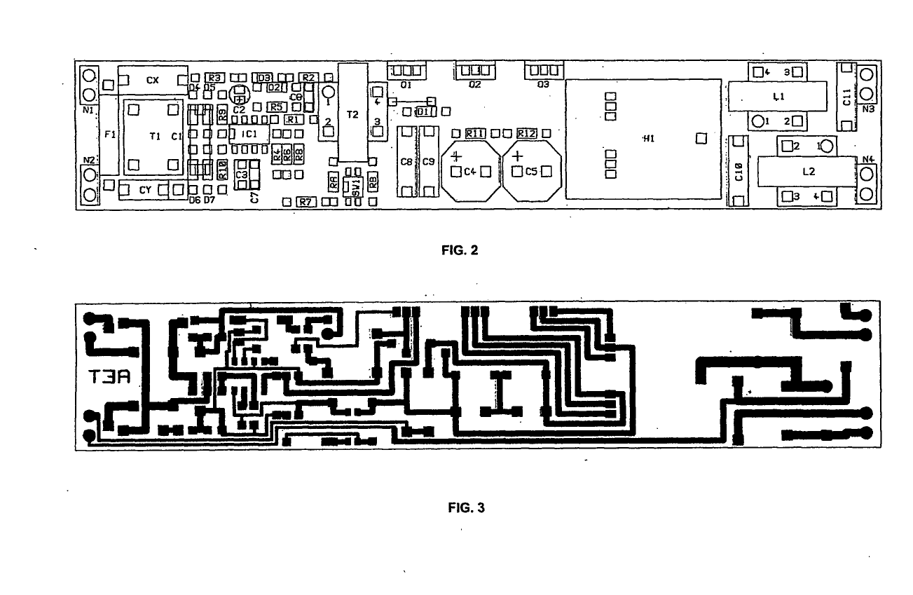

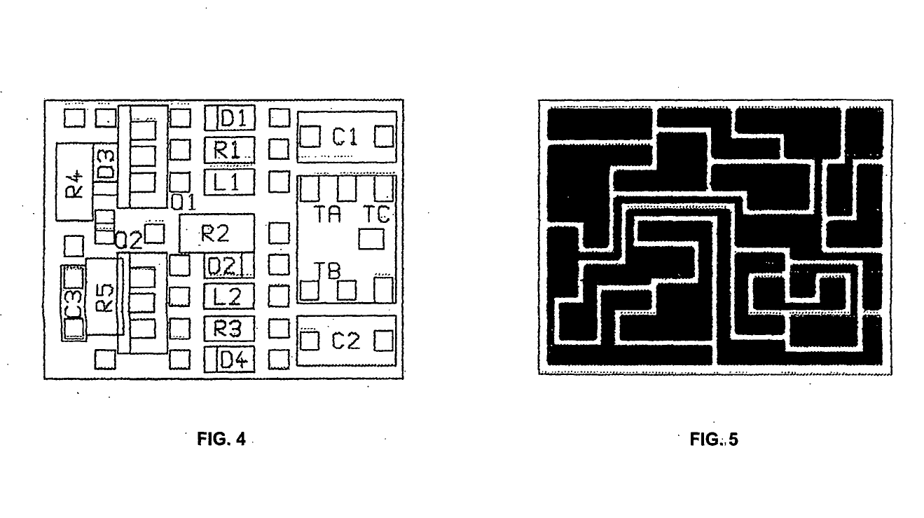

The layout of the components on the printed circuit boards of the apparatus is shown in FIGS. 2 and 4 using the references shown in Table 1, while the corresponding layout of the single layer printed circuit board tracks is shown in FIGS. 3 and 5. Changes in the component or track layout may result in changes in the performance of the circuit.

Other component values may be used to accomplish the aims of the invention.

The circuit efficiency is high because of low circuit losses through the switching transistors and via the ballast chokes. Waveform control plus the stopping of the inverter when the output is open circuit assists in increasing the efficiency.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the circuit may vary dependent on the particular application for which it is used without variation in the spirit and scope of the present invention.

In addition, although the preferred embodiments described herein are directed to a supply for fluorescent lamps, it will be appreciated by those skilled in the art that the teachings of the present invention can be applied to other systems such as fan motors or other constant AC loads, without departing from the scope and spirit of the present invention.

### INDUSTRIAL APPLICABILITY

The apparatus of the invention is used in the provision of a power supply for lamps or similar loads while providing a high power factor to the supply. The present invention is therefore industrially applicable.

1. An apparatus for providing a supply voltage to an AC load, the apparatus being connected to an AC supply and providing the AC current to a bucking transformer (109) under repetitively switched control, the bucking transformer output being rectified and supplying a half bridge inverter having at least two output transistors (146, 154) in half bridge arrangement, the inverter having a current output including a transformer winding (141), the transformer winding being coupled to two other windings (139, 140) operable to drive the inverter, whereby if no output current can be provided because of output circuit conditions, the inverter will not operate characterised in that the other windings (139, 140) drive the bases of the half bridge transistors (146, 154) and are DC isolated, and the base/emitter voltage of the transistors in the turn off direction is limited by a unidirectional component network (148, 149, 156, 157).

2. An apparatus as claimed in claim 1 wherein the unidirectional component network is the series combination of a diode and a resistor (148, 149, 156, 157).

3. An apparatus as claimed in claim 1 wherein only one of the output sides of the half bridge has a transistor emitter resistor (150) and only the other side of the bridge has a base pull up resistor (153).

4. An apparatus as claimed in claim 1 wherein there are two parallel transistors in each side of the half bridge arrangement (146, 147, 154, 155).

5. An apparatus as claimed in claim 1 wherein switched resistors (128, 130) may vary the inverter voltage.

6. A method of providing an AC output from an AC input comprising rectifying (107) the AC input to power a bucking converter, the converter being of controllable power factor, the smoothed converter output supplying an inverter, the inverter output current passing through a transformer winding (141), other windings of the transformer (139, 140) being operable to drive inverter control switches (146, 147, 154, 156) such that if the output circuit conditions reduce the output, current below a minimum, the inverter will not operate, characterised in that the transformer windings (139, 140) driving the inverter control switches are DC isolated and the switch control electrode is regulated to limit the applied control electrode voltage when the switch is cut off.

7. A method as claimed in claim 6 characterised in that the switch control electrode limiting is provided by a series resistor and diode (148, 149, 156, 157).

8. A method as claimed in claim 6 characterised in that the smoothed converter output is regulatable for voltage by switchable resistors (128, 130).

9. A method as claimed in claim 6 wherein the frequency of the inverter is substantially constant within the working voltage range.

10. A method as claimed in claim 6 wherein the inverter is a half bridge inverter.
